(19) United States
(12) Patent Application Publication
(10) Pub. No.: US 2007/0161445 A1
(43) Pub. Date: Jul. 12, 2007

(54) Silent chain

(75) Inventors: Kenichi Nagao, Osaka (JP); Tatsuya Konishi, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/592,681

(22) Filed: Nov. 3, 2006

(30) Foreign Application Priority Data
Jan. 11, 2006 (JP) 2006-003737

(51) Int. Cl. F16G 13/04

(52) U.S. Cl. 474/212

(57) ABSTRACT

In a silent chain, back surfaces of the link plates of a guide link row, a non-guide link row, or both, are formed with concave, arc-shaped portions having radii of curvature shorter than the minimum radius of curvature of the chain-contacting region of a chain guide shoe. The minimum height of the back surface of link plates having concave back portions is greater than the minimum distance between the inner tooth flanks and the nearest pin holes, and the minimum distance between the outer tooth flanks and the nearest pin holes.

### FIELD OF THE INVENTION

This invention relates to a silent chain for use in a transmitting rotation from a driving sprocket to one or more driven sprockets in various applications, such as in the timing drive system of the internal combustion engine of an automobile, or for driving an engine oil pump. More specifically, the invention relates to the reduction in friction loss due to sliding friction between a silent chain and a chain guide such as a tensioner lever, a fixed guide, or the like.

### BACKGROUND OF THE INVENTION

In recent years, because of the demand for greater load capacity, higher speed operation, and low maintenance, silent chains have gradually displaced toothed belts in engine timing drives.

A silent chain is a transmission chain, formed into an endless loop and usually composed of toothed link plates, guide plates, and connecting pins. Each link plate has a pair of teeth protruding in one direction, usually toward the inside of the loop, a pair of pin holes, and a back surface facing in a direction opposite to the direction in which the teeth protrude. The link plates are arranged in interleaved rows displaced from one another along the length of the chain. Every other row is a “guide row” having a guide plate at both of its ends. Thus, guide plates are provided along both sides of the chain. The pins extend through pin holes in the link plates, and connect the adjacent guide rows and non-guide rows in their interleaved relationship. The pins extend through the pin holes in the link plates with a small clearance allowing relative articulation of the guide rows and the non-guide rows, but are fixed to pin holes in the guide plates.

In a silent chain, when the teeth of a link plate engage with sprocket teeth, the sprocket teeth may be first engaged either by outer flanks of the link plate teeth or by inner flanks of the link plate teeth, depending on the transmission design. The flanks of the link plate teeth slide on the sprocket teeth during engagement. Unlike the engagement of a roller chain with a sprocket, in the case of a silent chain, the impact of the contact is comparatively small, and the generation of noise is suppressed.

A silent chain may be used in a timing drive system to maintain one or more camshafts in proper relationship with an engine crankshaft in order to open and close the engine's intake and exhaust valves at the proper times. As shown in FIG. 5, a silent chain Tc is driven by a crankshaft sprocket S1, and drives camshaft sprockets S2 and S2. The chain is in sliding contact with guide members, including a pivoted tensioner lever G1, that cooperates with a tensioner T to apply appropriate tension to the slack side of the chain, and a fixed guide G2 on the tension side of the chain. The tensioner lever G1 is pivoted on a shaft B1, which is fixed to the engine block E, and the fixed guide is mounted on bolts B2, which are also fixed to the engine block.

As shown in FIG. 4, the back surface 12 of each link plate 11 of a conventional silent chain includes a straight portion having a length approximately the same as the center-to-center distance of the pin holes of the link plate. Because of the long, straight, back portion, the link plate comes into sliding contact with the shoe of a guide member over a large contact area, and a large amount of friction loss occurs. A known solution to the problem of friction loss is to form the back surfaces of the link plates in the shape of a convex arc, as described in U.S. Pat. No. 5,758,484, granted Jun. 2, 1998. However, when a link plate is formed with a convex back surface, its mass is increased, with the result the that the overall mass of the chain is increased. Such an increase in mass is undesirable, especially when a significant amount of effort is being devoted to decreasing engine mass by decreasing the masses of its components.

An object of this invention is to address the above-mentioned problems, and to provide a silent chain in which the contact area between the backs of the link plates and a guide shoe is reduced in order to reduce friction loss, and in which, at the same time, a weight reduction can be realized.

### SUMMARY OF THE INVENTION

The silent chain according to the invention comprises an alternating series of first and second rows of link plates, each row extending widthwise with respect to the length of the chain. Each link plate comprises a pair of teeth, a pair of pin holes for receiving connecting pins, and a back surface facing in a direction opposite to the direction in which the teeth protrude. Each second row is displaced, in the direction of the length of the chain, from a pair of adjacent first rows in the series. The adjacent rows are interleaved and articulably interconnected by connecting pins, and a portion of the back surface of each of the link plates of at least the second rows of link plates have a concave arc-shaped portion.

Preferably, one set of rows from the group consisting of the first and second rows is a set of guide rows, and the link plates of each guide row are disposed between a pair of guide plates disposed on opposite sides of the chain. Preferably, the connecting pins of the chain are fixed in pin holes formed in the guide plates.

In a preferred silent chain according to the invention, in each link plate having a concave, arc-shaped, portion, the shortest distance between the concave arc-shaped portion and the tooth gap bottom is greater than the shortest distance from the inner flank surface of each tooth and the closest pin hole, and also greater than the shortest distance from the outer flank surface of each tooth and the closest pin hole.

When the silent chain is incorporated into a transmission having a guide member with a shoe surface positioned for sliding engagement with the backs of at least the link plates of the second rows of link plates, the concave, arc-shaped, portions of the backs of the link plates preferably have a radius of curvature smaller than the smallest radius of curvature of the shoe surface.

Since the backs of the link plates in at least every second row of link plates in the chain have a concave, arc-shaped, portion, when the chain comes into sliding contact with a shoe of a guide member such as a tensioner lever, a fixed guide or the like, only two small parts of the back surface of the link plate contact the shoe. Thus, the contact area is reduced with a resulting reduction in friction loss. Furthermore, since at least some of the link plates have backs with concave, arc-shaped, portions, a weight reduction can also be realized. Additionally, since the shape of the back surfaces of the links is different from that of the back surfaces of the links in a conventional silent chain, it is easy to identify the silent chain of the invention by visual inspection or by feel.

When the radius of curvature of the concave arc-shaped portion of the back of a link plate of a chain is smaller than a radius of curvature of the guide shoe on which the chain slides, the clearance formed between the concave, arc-shaped, portion and the shoe can function as an oil reservoir, reducing frictional resistance between the chain and the shoe.

Furthermore, when the shortest distance between the bottom surface of the concave, arc-shaped, portion of the back of a link plate and its tooth gap bottom is larger than the shortest distance between each inner tooth flank and the nearest pin hole and also larger than the shortest distance between each outer tooth flank and the nearest pin hole, a decrease in the strength of the link plate can be prevented.

### BRIEF DESCRIPTION OF THE DRAWINGS

FIG. 1 is a side elevational view of a link plate according to the invention;

FIG. 2 is side elevational view of the link plate, illustrating the manner in which the link plate slides on a and a shoe of a chain guide;

FIG. 3 is a partially broken-away perspective view of a part of a silent chain according to the invention;

FIG. 4 is a side elevational view of a conventional link plate; and

FIG. 5 is a schematic front elevational view of the timing drive system of an automobile engine.

### DETAILED DESCRIPTION OF THE PREFERRED EMBODIMENT

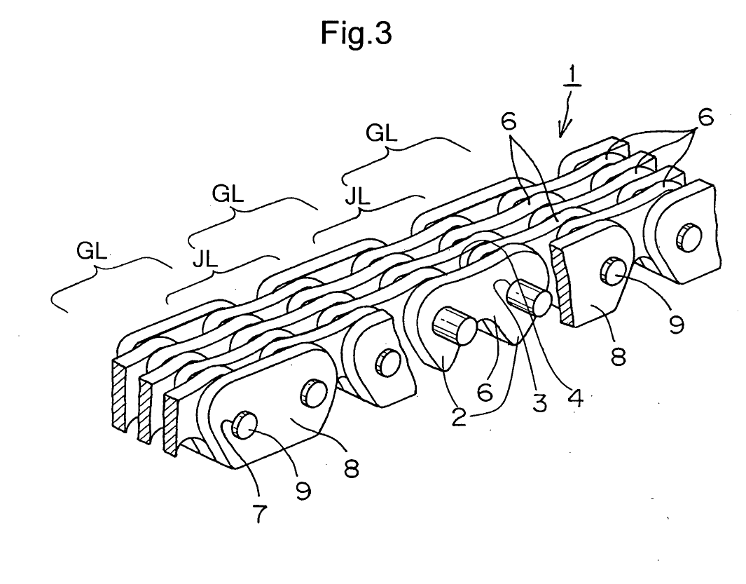

As shown in FIG. 3, in the silent chain 1, link plates 6 are disposed in alternating guide rows (or “guide lines”) GL and non-guide rows (or “joint lines”) JL. Each guide row has a guide plate 8 at each of its ends so that guide plates are provided along both sides of the chain. The non-guide rows do not have guide plates. The guide rows and the non-guide rows are disposed alternately along the length of the chain, and their plates are interleaved as shown in FIG. 3. Connecting pins 9 are fitted into pin holes in the guide plates 8, and extend, with a small clearance, through pin holes 3 in the link plates. The clearance between the holes 3 and the connecting pins 9 allows articulation between the guide rows and the non-guide rows so that the chain is flexible, and can be formed into an endless loop. The guide plates 8 do not have teeth, but are engageable with the sides of the teeth of a sprocket to prevent the chain from running off the sprocket.

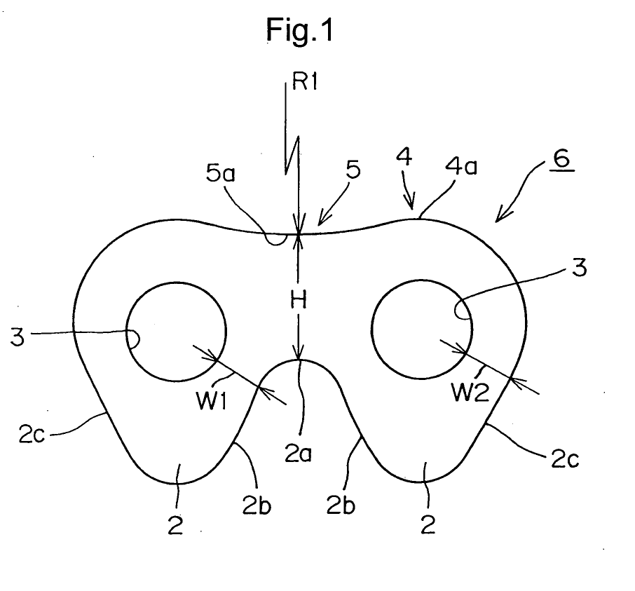

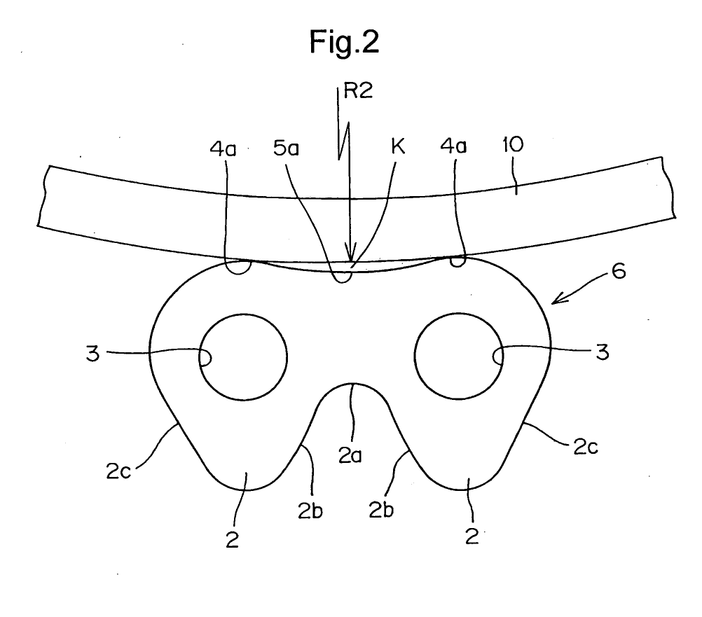

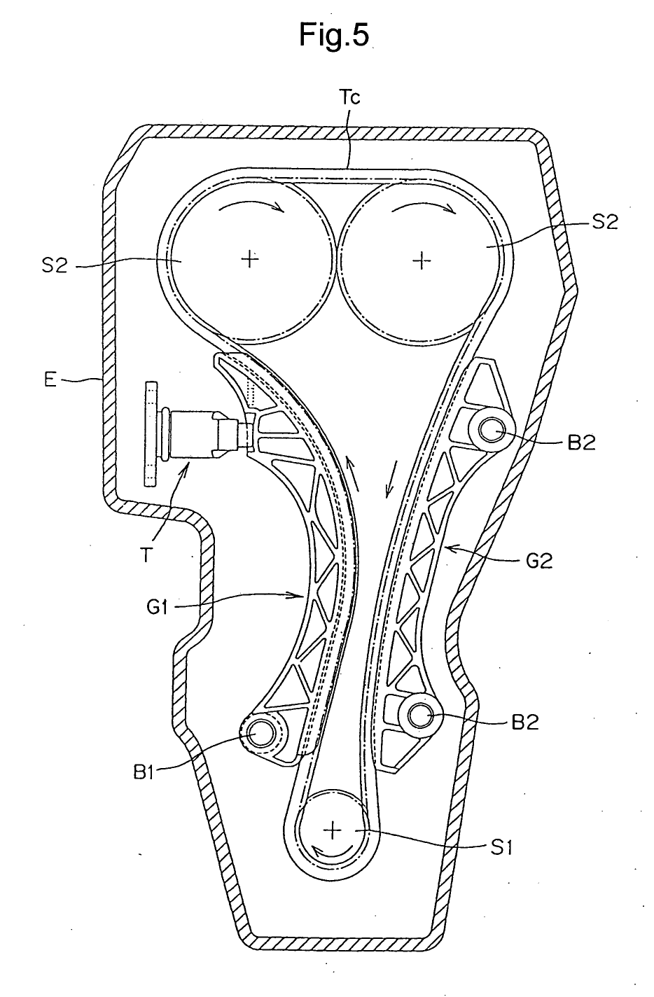

As shown in FIG. 1, the back surface 4 of the link plate 6 is formed with a concave, arc-shaped, portion 5, having a radius of curvature R1. The concave-portion 5 of the back of the link plate merges smoothly with convex peak portions 4a, which are concentric with the pin holes. When the silent chain 1 comes into sliding contact with a guide as shown in FIGS. 2 and 5, if the radius of curvature R2 of the contact region of the shoe 10 exceeds radius R1, the link plate only contacts the shoe at peaks 4a. Typically, the chain-contacting surface of the shoe is convex and circular, i.e., it has a constant radius of curvature. However, the chain-contacting surface of the shoe can have a varying curvature, and part of the chain-contacting surface can even be straight. The radius of curvature of the concave, arc-shaped, backs of the link plates should be smaller than the smallest radius of curvature of the chain-contacting portion of the shoe.

As illustrated in FIG. 1, the back surface height H of the link plate, that is, the shortest distance between the bottom 5a of the concave, arc-shaped, portion 5 and the tooth gap bottom 2a is larger than minimum wall thickness of the link plate. That is, H is larger than the shortest distance, W1, between an inner flank surface 2b of a tooth 2 and the inner circumferential surface of the nearest pin hole 3, and also larger than the shortest distance, W2, between an outer flank surface 2c of a tooth 2 and the inner circumferential surface of the nearest pin hole 3. It is preferable for W1 and W2 to be equal.

When the silent chain 1 comes into sliding contact with a shoe 10 of a guide such as a tensioner lever, a fixed guide, or the like, since the concave, arc-shaped, portion 5 is formed on the back surface 4 of the link plate 6, the entire back surface of the link plate 6 does not come into sliding contact with the guide member. Thus, the contact area is reduced and frictional resistance is reduced. Accordingly, the friction loss generated during power transmission is reduced. Furthermore, since the link plates 6 of the guide rows GL, or the non-guide rows JL, or both, have concave, arc-shaped, portions formed on back surfaces 4, the weight of the silent chain 1 can be reduced. Additionally, since the shape of the silent chain of the invention is different from that of a conventional silent chain, the chain according to the invention can be distinguished easily from the conventional silent chain by visual inspection or by feel.

Since the radius of curvature R1 of the concave, arc-shaped, portion 5 of the back surface of the link plate is smaller than the minimum radius of curvature R2 of the chain-contacting region of guide shoe 10, only the peak portions 4a of the back surface 4 come into sliding contact with the shoe 10. As shown in FIG. 2, a clearance K is formed between the concave, arc-shaped, portion 5 and the shoe 10. The clearance K functions as an oil reservoir, and aids in reducing friction between the silent chain and the shoe.

Since the back surface height H is greater than W1 and W2, a decrease in the strength of the link plate 6 can be avoided. When the teeth of a link plate start to engage with sprocket teeth (not shown) the tooth head of the link plate tooth 2 first comes into contact with a sprocket tooth. Then, while either an outer flank 2b, or an inner flank 2c, comes into contact with a sprocket tooth, the flank of the link plate tooth slides on the sprocket tooth. When the sprocket teeth and the teeth of the link plate are completely engaged, and the teeth of the link plate are seated on the sprocket, either of two actions can occur. The inner flanks 2b of teeth 2 of the link plate can be brought into pressing-contact with a sprocket tooth, and forced away from each other. In that case, the space between the teeth tends to widen. Alternatively, if the link late becomes seated on the sprocket with the outer flank surfaces 2c of its teeth brought into pressing-contact with sprocket teeth, the teeth of the link plate are pressed toward each other. In either case, a load is applied to the portion of the link plate located between the back surface 4 and the tooth gap bottom, and rupture can take place in the case of a conventional chain. However, in the silent chain according to the invention, a decrease in the link plate's rupture strength can be prevented. The load applied to the portion of the link plate between the tooth gap bottom 2a and the back of the link plate is greater than the load applied to the portions of the link plate between the inner flanks 2b and the inner circumferential surfaces of the pin holes 3, and also greater than the load applied to the portions between the outer flanks 2c and the inner circumferential surfaces of the pin holes 3. Therefore, if the back surface height H (FIG. 1) is made larger than the flank-to-pinhole distances W1 and W2 as shown in FIG. 1, a decrease in the rupture strength of the link plate can be prevented.

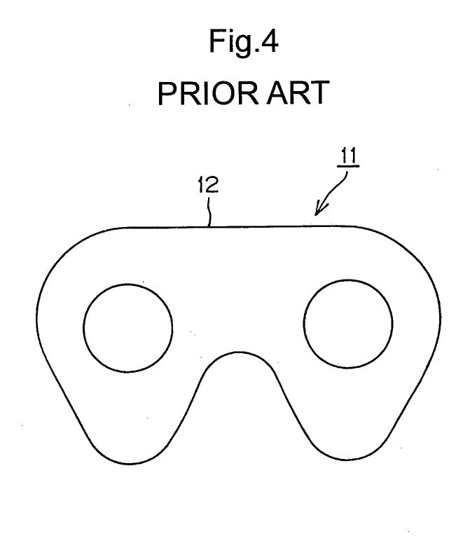

In the silent chain described above and shown in the drawings, both the guide row link plates and the non-guide row link plates have concave, arc-shaped, back portions 5. However, the silent chain can have concave, arc-shaped backs only on the link plates of the guide link rows or only on the link plates of the non-guide link rows. In such a case, conventional link plates such as shown in FIG. 4 can be used in the other rows. In other words, link plates having concave, arc-shaped, back portions may be utilized in the guide link rows GL, the non-guide link rows JL, or both.

In the chain described above and shown in FIG. 3, the link plates of the successive rows are interleaved individually. However, the invention can be embodied in various alternative versions, in which some or all of the link plates of the successive rows are interleaved in groups.

We claim:

1. A silent chain comprising an alternating series of first and second rows of link plates, each row extending widthwise with respect to the length of the chain, in which:
each link plate comprises a pair of teeth protruding in a first direction, a pair of pin holes for receiving connecting pins, and a back surface facing in a direction opposite to said first direction;
each second row is displaced, in the direction of the length of the chain, from a pair of adjacent first rows in the series;
the adjacent rows are interleaved and articulably interconnected by connecting pins; and
a portion of the back surface of each of the link plates of at least the second rows of link plates have a concave arc-shaped portion.

2. A silent chain transmission comprising a silent chain according to claim 1, and a guide member having a shoe surface positioned for sliding engagement with the backs of at least the link plates of the second rows of link plates, in which said concave arc-shaped portions have a radius of curvature smaller than the smallest radius of curvature of said shoe surface.

3. A silent chain according to claim 1, in which:
the teeth of each link plate having inner and outer flank surfaces, and are separated from each other by a tooth gap having a tooth gap bottom connecting the inner flank surfaces; and
in each link plate having a concave, arc-shaped, portion, the shortest distance between the concave arc-shaped portion and the tooth gap bottom is greater than the shortest distance from the inner flank surface of each tooth and the closest pin hole and also greater than the shortest distance from the outer flank surface of each tooth and the closest pin hole.

4. A silent chain transmission comprising a silent chain according to claim 3, and a guide member having a shoe surface positioned for sliding engagement with the backs of at least the link plates of the second rows of link plates, in which said concave arc-shaped portions have a radius of curvature smaller than the smallest radius of curvature of said shoe surface.

5. A silent chain according to claim 1, in which one set of rows from the group consisting of the first and second rows is a set of guide rows, in which the link plates of each guide row are disposed between a pair of guide plates disposed on opposite sides of the chain, and in which the connecting pins of the chain are fixed in pin holes formed in the guide plates.

6. A silent chain transmission comprising a silent chain according to claim 5, and a guide member having a shoe surface positioned for sliding engagement with the backs of at least the link plates of the second rows of link plates, in which said concave arc-shaped portions have a radius of curvature smaller than the smallest radius of curvature of said shoe surface.

7. A silent chain according to claim 5, in which:
the teeth of each link plate having inner and outer flank surfaces, and are separated from each other by a tooth gap having a tooth gap bottom connecting the inner flank surfaces; and
in each link plate having a concave, arc-shaped, portion, the shortest distance between the concave arc-shaped portion and the tooth gap bottom is greater than the shortest distance from the inner flank surface of each tooth and the closest pin hole and also greater than the shortest distance from the outer flank surface of each tooth and the closest pin hole.

8. A silent chain transmission comprising a silent chain according to claim 7, and a guide member having a shoe surface positioned for sliding engagement with the backs of at least the link plates of the second rows of link plates, in which said concave arc-shaped portions have a radius of curvature smaller than the smallest radius of curvature of said shoe surface.
